(19) United States
(12) Patent Application Publication
(10) Pub. No.: US 2014/0299821 A1
(43) Pub. Date: Oct. 9, 2014

(54) METHOD FOR PRODUCING A METAL NANOPARTICLE DISPERSION, METAL NANOPARTICLE DISPERSION, AND USE OF SAID METAL NANOPARTICLE DISPERSION

(71) Applicant: BAYER INTELLECTUAL PROPERTY GMBH, Monheim (DE)

(72) Inventors: Daniel Rudhardt, Koln (DE); Bibin Thomas Anto, Singapore (SG); Chaiman Deivaraj Thelvanayagam, Singapore (SG); Fransiska Cecilia Kartawidiala, Singapore (SG); Stefan Bahnmuller, Singapore (SG)

(73) Assignee: BAYER INTELLECTUAL PROPERTY GMBH, Monheim (DE)

(21) Appl. No.: 14/355,639

(22) PCT Filed: Oct. 30, 2012
(86) PCT No.: PCT/EP2012/071499

§ 371 Date: May 1, 2014

(30) Foreign Application Priority Data
Nov. 3, 2011 (DE) 10 2011 085 642.0

(51) Int. Cl. C09D 11/00

(52) U.S. Cl. CPC C09D 11/52
USPC 252/514

(57) ABSTRACT

The invention relates to a method for producing a metal nanoparticle dispersion, in particular a silver nanoparticle dispersion, wherein after the production of nanoscale metal particles, stabilized by means of at least one auxiliary dispersing agent containing at least one free carboxylic acid group or salt thereof as a functional group, in at least one liquid dispersant (solvent), flocculation of the metal nanoparticles is deliberately caused, the formed metal nanoparticle flocculation is dispersed again in at least one liquid dispersant, optionally by adding a base, and the metal nanoparticle dispersion is set to a desired metal nanoparticle concentration. The invention further relates to a metal nanoparticle dispersion, in particular a silver nanoparticle dispersion, in particular produced by means of the method according to the invention, and to the use of said metal nanoparticle dispersion.

The invention relates to a method for producing a metal nanoparticle dispersion, particularly a silver nanoparticle dispersion, more particularly for producing electrically conductive coatings and structures, also referred to as a metal nanoparticle sol, which has metal nanoparticles stabilized with at least one dispersing assistant in an aqueously based liquid dispersion medium, and also, in particular, to metal nanoparticle sols produced by this method, and to the use thereof.

Metal particle sols containing silver nanoparticles are employed for purposes including the production of conductive coatings and the production of inks for inkjet and screen printing processes for the production of conductive, structured coatings, in the form of microstructures, for example, by means of printing processes. The focus here to an increasing extent is on the coating of flexible plastics substrates, such as for the production of flexible RFID tags, for example. In order to achieve sufficient conductivity, the coatings applied by means of the silver nanoparticle sols must be dried and sintered at elevated temperatures for a sufficient time, and this imposes a considerable thermal load on the plastics substrates.

A concern that therefore exists is to lower the sintering times and/or the sintering temperatures that are needed for achieving sufficient conductivities by means of appropriate measures in such a way that such thermal load on the plastics substrates can be lessened.

It is desirable, furthermore, for the metal nanoparticle sols to be able to be stably stored over a prolonged period and hence to be suitable even after storage for use, more particularly for producing conductive coatings on substrates and/or for producing inks for the production of conductive, structured coatings, by means of inkjet printing, for example.

Gautier et al. in various publications describe N-acetyl-L-cysteine (NALC) and N-isobutyrylcysteine protected gold nanoparticles having an average particle size of <2 nm and their production (Gautier C, Bürgi T, Vibrational circular dichroism of N-acetyl-L-cysteine protected gold nanoparticles, Chem. Commun. (2005) 5393; Gautier C, Bürgi T, Chiral N-isobutyryl-cysteine protected gold nanoparticles: preparation, size selection and optical activity in the uv-vis and infrares, J. Am. Chem. Soc. 128 (2006) 11079). The production described does not, however, include flocculation of the nanoparticles. The gold nanoparticles protected with the chiral amino acids were isolated in each case in the form of a black powder. The production of a stable metal nanoparticle dispersion or the sintering properties thereof were not described.

Bieri et al., in Absorption kinetics, orientation, and self assembling of N-acetyl-L-cysteine on gold: A combined ATR.IR, PM-IRRAS, and QCM study, J. Phys. Chem B, 109 (2005), 22476, describe the use of N-acetyl-L-cysteine as a self-assembled monolayer on gold-coated substrates. The monolayer was formed using a solution of N-acetyl-L-cysteine in ethanol, to which the gold substrate was exposed. The self-assembly of the N-acetyl-L-cysteine molecules on the gold substrate was investigated.

In the publication by C. S. Weisbecker et al. in Langmuir 1996, 12, 3763-3772, a description is given of the production and characterization of self-assembled monolayers composed of alkanethiolates on gold colloids in aqueous dispersion. Additionally, the relationship between the rate of formation of the gold colloids and the chemiadsorption of the alkanethiols on the gold particles as a function of the pH was investigated.

None of the documents identified above provides any indication as to how the sintering times and/or sintering temperatures of coatings of metal nanoparticles, especially silver nanoparticles, that are required for the attainment of sufficient conductivities can be lowered in order to reduce the thermal load on plastics substrates.

Laid-open specification DE 10 2008 023 882 A1 describes the preparation of an aqueous, silver-containing ink formulation which as well as silver particles with a bimodal size distribution comprises at least one polymer. Using this formulation it is possible, by means of printing processes, to apply surfaces and to obtain electrically conductive structures by means of a further treatment at temperatures of ≦140° C. The silver nanoparticle sol used for producing the ink was obtained by reaction of silver nitrate with aqueous sodium hydroxide solution in the presence of a polymeric dispersing assistant, and subsequent reduction with formaldehyde, and then was finally purified by membrane filtration.

Bibin T. Anto et al., in Adv. Funct. Mater. 2010, 20, 296-303, describe the production of gold and silver nanoparticles which are protected with an ionic monolayer, composed for example of various thiols and ω-carboxylalkylthiols, and which exhibit ready dispersibility in water and glycols. The production of the gold nanoparticles encompasses the reduction of AuCl₄⁻ in toluene in the presence of the desired thiols in a two-phase system with aqueous NaBH₄ solution, it being essential here to control the rate of addition of the NaBH₄ solution. After they have been formed, the gold nanoparticles pass into the aqueous phase and are precipitated with tetrahydrofuran, and purified by repeated, multiple precipitation and redispersion in water. The isolated gold nanoparticles were then dispersed in ethylene glycol, for example. Silver nanoparticles were obtained in a similar way in a single-phase system composed of H₂O:MeOH. The stability displayed by the metal nanoparticle dispersions produced was good. The dispersions can be applied to a substrate and sintered for example at temperatures of about 145-150° C., allowing conductivities of 1×10⁵ S/cm to be obtained. According to Anto et al., however, the production described does not include flocculation of the nanoparticles.

A method for producing conductive surface coatings that is also suitable for the coating of plastics surfaces is described in EP-A 2 369 598. This method uses electrostatically stabilized silver nanoparticles which have a zeta potential in the range of 20-50 mV in the dispersion medium used, at a pH of 2-10. The electrostatic stabilizer proposed therein comprises, for example, dicarboxylic or tricarboxylic acids, especially trisodium citrate, since the latter melts at just 153° C., and decomposes at 175° C. The described silver nanoparticle dispersion with trisodium citrate as electrostatic stabilizer was applied to a surface and then sintered for example for 10 minutes at 140° C., allowing a conductivity of >1.25·10⁶ S/m to be obtained.

In the as yet unpublished European application 10188779.2, a description is given of the production of metal particle sols, in which the metal salt solution used for their production comprises ions selected from the group encompassing ruthenium, rhodium, palladium, osmium, iridium, and platinum, as a result of which the silver nanoparticles receive stabilizing doping with these ions. The silver nanoparticles described were stabilized sterically with Disperbyk 190 (Byk GmbH) or PVP as dispersing assistant, and doped in particular with Ru. In connection with the simultaneous combining of the reactant solutions employed, silver nanoparticles with doping of this kind enabled a significantly reduced sintering time and a significantly lower sintering temperature.

It was an object of the present invention to provide a further simple method for producing stable, or colloid-chemically stable, metal nanoparticle sols, and/or to further improve the colloid-chemical stability and/or the performance properties of the metal nanoparticle dispersions produced.

An alternative object of the present invention was to find a metal nanoparticle sol comprising metal nanoparticles, and also a method for producing it, with which the sintering times and/or sintering temperatures necessary in order to attain sufficient conductivities can be lowered in such a way that it is possible to reduce the thermal load, particularly in applications with plastics substrates.

The present invention provides a method for producing a metal nanoparticle sol that is simple to carry out and with which metal nanoparticle sols having improved performance properties can be obtained.

Having proven particularly advantageous in this context is a method in which, following the production of stabilized nanoscale metal particles in at least one liquid dispersion medium (solvent), flocculation of the metal nanoparticles is deliberately induced, and the metal nanoparticle floc formed is redispersed in at least one liquid dispersion medium (solvent), optionally by addition of a base, and the metal nanoparticle dispersion is set to a desired metal nanoparticle concentration.

A metal nanoparticle sol or metal nanoparticle colloid is also referred to in accordance with the invention as a metal nanoparticle dispersion.

The present invention accordingly provides a method for producing a metal nanoparticle dispersion, more particularly a silver nanoparticle dispersion, more particularly having a metal nanoparticle content of ≧20 wt %, based on the total amount of the metal nanoparticle dispersion, in which
a) a metal salt, at least one dispersing assistant comprising at least one free carboxylic acid group or salt thereof as functional group, and a reducing agent, optionally in the presence of hydroxide ions, are combined in solution and reacted with one another to form stabilized metal nanoparticles;
b) flocculation of the resultant metal nanoparticles is generated in the reaction mixture obtained in step a);
c) the floc obtained in step b) is separated from at least part of the rest of the reaction mixture;
d) the floc obtained in step c) is redispersed with addition of at least one dispersion medium, optionally with addition of a base;
e) the metal nanoparticle dispersion obtained in step d) is optionally purified; and
f) the desired concentration of stabilized metal nanoparticles for the metal nanoparticle dispersion obtained in step d) or e) is set.

The metal nanoparticle dispersion produced in accordance with the invention, also referred to as a metal nanoparticle sol, has preferably a metal nanoparticle content, more particularly silver particle content (Ag and dispersing assistant), of ≧20 wt % to ≦60 wt %, as for example 30 wt % or 50 wt %, based on the total amount of the metal nanoparticle sol. It is, however, also possible, optionally, for higher metal nanoparticle contents to be attained.

Metal nanoparticles, more particularly silver nanoparticles, are understood in the context of the invention to be those having a d₅₀ of less than 300 nm, preferably having a d₅₀ of 5 to 200 nm, more preferably of 10 to 150 nm, very preferably of 20 to 140 nm, as for example of 40 to 80 nm, as measured by means of dynamic light scattering. Suitable for the measurement by means of dynamic light scattering is, for example, a Malvern Dynamic Light Scattering Particle Size Analyzer from Malvern Instruments GmbH.

The metal nanoparticles are stabilized by means of at least one dispersing assistant and are dispersed in at least one solvent, also referred to as liquid dispersion medium.

In the method of the invention, the nanoscale and submicroscale metal particles, preferably silver particles, are produced in step a) in the presence of at least one dispersing assistant which has at least one carboxylic acid group (—COOH) or a carboxylate group (—COO⁻) as ionizable functional group. By this means the metal nanoparticles are coated on their surface with the dispersing assistant, and stabilized. The dispersing assistant is also referred to as a protective colloid.

In the context of the method of the invention, the production of the reaction mixture comprising the reactants, or reactant solutions, in step a) of the method of the invention can take place in different variants.

In step a), for example, in a first substep, a metal salt solution and a solution comprising hydroxide ions may react with one another in the presence of at least one dispersing assistant, and the resulting reaction mixture may be reacted, in a subsequent substep, with a reducing agent, or a reducing agent solution, to form metal nanoparticles.

Alternatively in step a), for example, it is also possible first for the reducing agent, or a reducing agent solution, the at least one dispersing assistant in solution, and optionally a solution comprising hydroxide ions to be mixed with one another and introduced as an initial charge. A metal salt solution may then be added to this reaction mixture, and the reduction to metal can take place. It is also possible in accordance with the invention for no hydroxide ions, or solution comprising hydroxide ions, to be used in step a).

Advantageously, step a) may be carried out in accordance with the invention in a single-phase system with regard to the solvents used for the reactants, these solvents being also referred to as liquid dispersion media. For all reactants, such as metal salts, hydroxide ions in solution, the reducing agent, and the dispersing assistant, water, for example, may be used as liquid dispersion medium, and/or water-miscible solvents.

The temperature at which method step a) is carried out may be situated, for example, in a range from ≧0° C. to ≦100° C., preferably ≧5° C. to ≦70° C., as for example at 60° C., more preferably ≧10° C. to ≦30° C.

Selected preferably for the reduction is an equimolar ratio or an excess of the equivalents of the reducing agent in relation to the metal cations to be reduced; for example, a molar ratio of θ1:1 to ≦100:1, preferably ≧1.5:1 to ≦25:1, more preferably ≧2:1 to ≦5:1.

In step a), in accordance with the invention, the ratio of metal to dispersing assistant or dispersing assistants may be selected within a molar ratio of ≧1:0.01 to ≦1:10. With preference it is possible to employ a molar ratio of metal to dispersing assistant or dispersing assistants of ≧1:0.1 to ≦1:7, as for example from ≧1:0.25 to ≦1:0.5.

The selection of a ratio of this kind for the dispersing assistant relative to the metal particles ensures on the one hand that the metal particles are covered with dispersing assistant to an extent such that the desired properties, such as stability and redispersibility, are maintained. Optimum coverage of the metal nanoparticles with the stabilizing dispersing assistant is obtained, and at the same time unwanted side-reactions, with the reducing agent, for example, are avoided. Another effect of this is to achieve extremely good further processing.

The generation of flocculation of the formed metal nanoparticles, stabilized with dispersing assistant, in step b) may take place, for example, by waiting, such as by leaving the reaction mixture from a) to stand without disruption, as for example by simply leaving it to stand without stirring overnight. Alternatively or cumulatively, the flocculation may be induced and/or assisted by addition of a base or an acid. Flocculation in accordance with the invention is understood to refer to the agglomeration of at least some of the metal nanoparticles, in other words the loose aggregation of the metal nanoparticles into larger particles. This aggregation and the associated particle enlargement may be influenced, for example, by surface properties of the particles and by interfacial forces, of the kind dictated, for example, by the functional groups in the dispersing assistant. In accordance with the invention, accordingly, reversible agglomeration of metal nanoparticles is deliberately waited for or generated.

In step c), the floc of the metal nanoparticles is separated from at least part of the rest of the reaction mixture. This may be done, for example, by a mechanical separation method, such as filtration or decanting, for example. This makes it possible to remove impurities from the metal nanoparticle dispersion, such as unwanted, dissolved accompanying substances and/or salts. Moreover, the removal of the rest of the reaction mixture has the effect of concentrating, possibly even of isolating, the flocculated metal nanoparticles.

In step d) of the method of the invention, the floc of the metal nanoparticles obtained in step c) is redispersed with addition of at least one liquid dispersion medium, optionally with addition of a base. In this case, through the addition of at least one solvent, water for example, the associations (agglomerate) of the metal nanoparticles formed in step b) are redissolved. Especially if in step a) no hydroxide ions, or no base, have been used, and the flocculation in step b) has been induced or assisted by an acid, the redispersion in step d) is carried out preferably in the presence of a base, more preferably an organic base, such as triethylamine. The inventively envisaged flocculation and the redispersion in fresh solvent make it possible, as already elucidated above, to remove—to a large extent at least—impurities, such as unwanted, dissolved accompanying substances and/or salts, for example, including more particularly impurities such as by-products, from the reduction of the metal particles, for example, or excess dispersing assistant, or ions, or surfactants, which advantageously influences the sintering properties of the metal nanoparticle sol.

The liquid dispersion medium or media for the redispersion in step d) preferably comprise water or mixtures comprising water and organic, preferably water-soluble organic solvents. In addition, however, other polar solvents are conceivable, as for example if the method is to be carried out at temperatures below 0° C. or above 100° C. or the resulting product is to be incorporated into matrices in which the presence of water would be disruptive. Use may be made, for example, of polar protic solvents such as alcohols and acetone, polar aprotic solvents such as N,N-dimethylformamide (DMF) or apolar solvents such as CH₂Cl₂. The mixtures have a water content of preferably at least 50 wt %, more preferably at least 60 wt %, very preferably at least 70 wt %. With particular preference the liquid dispersion medium or media comprise water or mixtures of water with alcohols, aldehydes and/or ketones, more preferably water or mixtures of water with monohydric or polyhydric alcohols having up to four carbon atoms, such as methanol, ethanol, n-propanol, isopropanol, or ethylene glycol, for example, aldehydes having up to four carbon atoms, such as formaldehyde, for example, and/or ketones having up to four carbon atoms, such as acetone or methyl ethyl ketone, for example. An especially preferred liquid dispersion medium is water.

In step e), the metal nanoparticle dispersion obtained in step d) may optionally be purified, in the form for example of a washing step and/or by filtration, allowing the removal of further impurities. By this means it is possible optionally to improve once again the performance properties of the resulting metal nanoparticle sol. With the method of the invention, however, it is also possible to obtain stable metal nanoparticle, more particularly silver nanoparticle, dispersions, particularly on an aqueous basis, even without one or more additional purification steps, and to generate conductive surface coatings and surface structures from such dispersions by an aftertreatment at advantageously low temperatures.

In step f) of the method of the invention, the desired concentration of stabilized metal nanoparticles is set for the dispersion obtained in step d) or e), it being set more particularly to a metal nanoparticle content of ≧20 wt %, based on the total amount of the metal nanoparticle dispersion. By this means it is possible to obtain the concentration that is optimum or is needed for a particular application. The metal nanoparticle concentration may be set, for example, by a concentration process, by removal of solvent, by means of membrane filtration, for example. Alternatively the desired concentration may be set by adding only a particular amount of solvent in step d). In accordance with the invention, the setting of the desired metal concentration may also be associated with a purification. Alternatively, another purification step may also follow. The setting of the concentration and/or the purification of the metal nanoparticle dispersion in step f) may be accomplished, for example, by means of dialysis or direct flow filtration by centrifuging, or by means of stirred cell ultrafiltration apparatus, or by means of tangential flow filtration.

The metal nanoparticle sols produced in accordance with the invention are notable advantageously for a high colloid-chemical stability, which is also retained on further concentration. The term “colloid-chemically stable” here denotes that the properties of the inventively produced colloidal nanoparticle dispersion do not change greatly even during the customary storage times prior to application—in other words, for example, that no substantial aggregation or other flocculation of the colloid particles takes place.

With the method of the invention, furthermore, it is possible in a simple way to produce metal, more particularly silver, nanoparticle sols which for the attainment of sufficient conductivities permit surprisingly low sintering temperatures of ≦140° C., preferably at ≦130° C., as for example at ≦120° C., with relatively short sintering times of ≦30 minutes, preferably sintering times of a few minutes, and hence are also suitable, in particular, for applications involving temperature-sensitive substrates.

Suitable metals for the metal particle sols are considered in particular to include silver, gold, copper, platinum, and palladium. A particularly preferred metal is silver. In addition to these metals, other metals as well may be incorporated into the metal particle sol. For this purpose, in particular, further metals such as ruthenium, rhodium, palladium, osmium, iridium, and platinum are contemplated.

In accordance with the invention it is also possible, advantageously, to do without the introduction, into the reaction mixture and/or into the metal nanoparticle sol, of further metals and/or metal compounds, more particularly selected from the group of ruthenium, rhodium, palladium, osmium, iridium, and platinum, in the form of the metal and/or of at least one metal compound.

In one embodiment of the method of the invention it is possible in step a) to use a further metal salt or metal salt solution in addition to the metal salt, more particularly to use a copper salt, or gold salt, and/or solutions thereof. In other words, the silver nanoparticles produced in accordance with the invention may further comprise copper and/or gold. Alternatively, the silver salt may be replaced by a copper or a gold salt.

In the case of the solution comprising at least one metal salt of gold and/or copper, for example, those used may comprise a cation of gold or copper and at least one of the counteranions to the metal cations, selected from the group of nitrate, chloride, bromide, sulfate, carbonate, acetate, acetylacetonate, tetrafluoroborate, tetraphenylborate, or alkoxide anions (alcoholate anions).

In one embodiment of the method of the invention, the dispersing assistant comprises not only the at least one carboxylic acid group (—COOH) or carboxylate group (—COO⁻) but also at least one further ionizable, more particularly protonatable or deprotonatable, functional group. This further functional group may be selected, for example, from —COOH, —NH—, —SO₃H, —PO(OH)₂, —SH, their salts and derivatives, and also mixtures of these various functional groups. The dispersing assistant may in accordance with the invention have two or more identical functional groups, such as two or more carboxylic acid groups, for example, or else two or more different functional groups. It has emerged advantageously that such dispersing assistants are able to stabilize the metal nanoparticles to particularly good effect and that the resultant metal nanoparticle dispersions therefore have a high colloid-chemical stability.

In one preferred embodiment, the at least one dispersing assistant may be selected from low molecular mass amino acids or their salts, dicarboxylic or tricarboxylic acids having up to 8 carbon atoms or their salts, and/or mercaptocarboxylic acids having 2, 3, 4, 5, 6, 7, or 8 carbon atoms or their salts; in the case of chiral compounds, more particularly amino acids, the invention also encompasses their stereoisomers, such as enantiomers and diastereomers, and also their mixtures, as for example their racemates. Particularly preferred dispersing assistants for stabilizing the metal nanoparticles are N-acetyl-cysteine, mercaptopropionic acid, mercaptohexanoic acid, citric acid or citrates, such as lithium, sodium, potassium or tetramethylammonium citrate, for example. Generally speaking, in an aqueous dispersion, saltlike dispersing assistants of these kinds are present very largely in a form in which they are dissociated into their ions, and the respective anions are able, for example, to bring about electrostatic stabilization of the metal nanoparticles.

In one preferred embodiment of the method of the invention at least two different dispersing assistants are used in step a), with at least one dispersing assistant having at least one carboxylic acid group (—COOH) or a carboxylate group (—COO⁻) as ionizable functional group. Preferably at least two or all of the dispersing assistants used have at least one carboxylic acid group (—COOH) or a carboxylate group (—COO⁻) as ionizable functional group. It is possible for the different dispersing assistants to be present in identical or in different concentrations.

In one preferred method variant of the invention, the dispersing assistant or assistants employed are low molecular mass compounds (small molecules), i.e., nonpolymeric or oligomeric compounds. These have the capacity to support the attainability of an extremely low sintering temperature in conjunction with an extremely short sintering time for the resultant metal nanoparticle sol, in order to achieve a good conductivity.

In the context of the invention it is also possible for one or more of the stated dispersing assistants to be used together with one or more polymeric dispersing assistants comprising at least one carboxylic acid group or carboxylate group as a functional group. One example of a polymeric dispersing assistant suitable in accordance with the invention is the ammonium polyacrylate-based dispersing assistant available commercially from Byk under the trade name Byk®154. In accordance with the invention, when different dispersing assistants are used, they are also referred to as mixed dispersing assistant systems. The low molecular mass dispersing assistant or assistants are used preferably, in relation to the polymeric dispersing assistant or dispersing assistants, in a weight ratio (w/w) of 1:1 to 10 000:1, as for example from 500:1 to 1000:1. Through the selection of this ratio of small-molecule dispersing assistants to polymeric dispersing assistants it is possible for properties such as the optimum steric and/or electrostatic stabilization of the metal particles, and also an extremely low sintering temperature in conjunction with extremely short sintering times, to be advantageously harmonized.

The metal salt, preferably the silver salt, or the metal salt solution, preferably the silver salt solution, is preferably of the kind comprising metal cations, preferably silver cations, and anions selected from the group of nitrate, perchlorate, fulminates, citrate, acetate, tetrafluoroborate, or tetraphenylborate. Particularly preferred are silver nitrate, silver acetate, or silver citrate. Especially preferred is silver nitrate.

In accordance with the invention, the metal ions are present in the metal salt solution preferably in a concentration of ≧1.5 wt % to ≦80 wt %, more preferably ≧2 wt % to ≦75 wt %, very preferably ≧2.5 wt % to ≦50 wt %, as for example ≧2.5 wt % to ≦5 wt %, based on the total weight of the metal salt solution. This concentration range is advantageous since at lower concentrations the nanosol solids content attained may be too low, with the possible consequence of a need for costly aftertreatment steps, which are avoided in accordance with the invention. Moreover, aggregation of the metal particles, in other words an irreversible conglomeration, or irreversible precipitation of the particles is avoided.

The hydroxide ions, or the solution comprising hydroxide ions that is used in step a), are or is preferably obtainable from bases selected from the group encompassing LiOH, NaOH, KOH, Mg(OH)₂, Ca(OH)₂, NH₄OH, aliphatic amines, aromatic amines, alkali metal amides and/or alkoxides, and their solutions. Particularly preferred bases are NaOH and KOH and their solutions, more particularly their aqueous solutions. Bases of these kinds have the advantage that they are inexpensively obtainable and are readily disposed of on subsequent wastewater treatment of the solutions from the method of the invention.

The concentration of the hydroxide ions in the solution comprising hydroxide ions may be situated, advantageously and preferably, within a range from ≧0.001 mol/1 to ≦2 mol/l, more preferably ≧0.01 mol/1 to ≦1 mol/1, very preferably ≧0.1 mol/1 to ≦0.7 mol/1.

The reducing agent is preferably selected from the group encompassing polyalcohols, aminophenols, amino alcohols, aldehydes, such as formaldehyde, sugars, tartaric acid, citric acid, ascorbic acid and also the salts thereof, thioureas, hydroxyacetone, iron ammonium citrate, triethanolamine, hydroquinone, dithionites, such as sodium dithionite, hydroxymethanesulfinic acid, disulfites, such as sodium disulfite, form-amidinesulfinic acid, sulfurous acid, hydrazine, hydroxylamine, ethylenediamine, tetramethylethylene-diamine, hydroxylamine sulfate, borohydrides, such as sodium borohydride, alcohols, such as ethanol, n-propanol, isopropanol, n-butanol, isobutanol, sec-butanol, ethylene glycol, ethylene glycol diacetate, glycerol and/or dimethylaminoethanol. Particularly preferred reducing agents are formaldehyde and sodium borohydride.

The reactant solutions and/or the reaction mixture obtained in step a) may optionally be admixed with further substances such as low molecular mass additives, such as salts, extraneous ions, surfactants, and complexing agents, and in this way the performance properties of the metal nanoparticle dispersion may be further optimized.

In another embodiment of the method of the invention, the flocculation of the resultant metal nanoparticles in step b) can be accomplished by leaving the reaction mixture to stand preferably for a time of 1 minute to 24 hours, more preferably from 6 to 18 hours, very preferably from 8-12 hours, as for example 10 hours, by leaving it to stand overnight, for example. Alternatively or cumulatively, the flocculation can be induced and/or supported by addition of a base or an acid. Flocculation is understood in accordance with the invention to mean that at least some of the metal nanoparticles agglomerate. In accordance with the invention, therefore, (reversible) agglomeration of metal nanoparticles is waited for or generated in a targeted way.

In one preferred embodiment of the method of the invention, flocculation may be generated advantageously by using a base or an acid advantageously to adjust the pH of the reaction mixture obtained in step a) in correspondence with at least one pKa of the dispersing assistant or its functional group/s. Thus, for example, by acidification, the pH of the reaction mixture may be adjusted preferably such that it is below the pKa of the at least one free carboxylic acid group in the dispersing assistant. Alternatively, through addition of a base, the pH of the reaction mixture may be adjusted such that it lies above the pKa of a functional group, as for example of a —NH₂⁺ group in an amino acid, such as N-acetylcysteine.

Bases which can be used in this context include inorganic and organic bases, selected for example from the group encompassing LiOH, NaOH, KOH, Mg(OH)₄, Ca(OH)₂, NH₄OH, aliphatic amines, aromatic amines, alkali metal amides and/or alkoxides, and/or solutions thereof. Particularly preferred bases are NaOH and triethylamine, and/or their aqueous solutions. Such bases have the advantages already stated above.

Examples of acids which can be used include hydrochloric acid, sulfuric acid, phosphoric acid, or acetic acid. Concentrated hydrochloric acid is used with preference. The stated acids have the advantage that they are inexpensively obtainable and are readily disposed of on subsequent wastewater treatment of the solutions from the method of the invention.

In another embodiment of the method of the invention, the separation of the floc in step c) from at least part of the rest of the reaction mixture may be accomplished by means of a mechanical separation method, as for example by decanting, centrifuging (sedimentation in a gravity field or centrifugal field), or by filtration. These separation methods are easy to implement and are effective in removing impurities, examples being unwanted, dissolved accompanying substances and/or salts, from the metal nanoparticle dispersion.

In a further embodiment of the method of the invention, the reaction mixture separated from the floc in step c) may be used again in step b), optionally with addition of a base or an acid. Bases and acids which can be used are those already stated above. A preferred base is NaOH; a preferred acid is concentrated HCl. In this way, flocculation of metal nanoparticles still in solution in the reaction mixture can be achieved, and accordingly, in a simple way, the yield of stabilized metal nanoparticles can be improved. The metal nanoparticles recovered from this procedure, optionally after purification, may advantageously be processed further together with the initially flocculated metal nanoparticles, and the same quality of the resultant silver nanoparticle sols can be obtained. This step may optionally also be repeated multiply. It has surprisingly emerged that the metal nanoparticles additionally recovered from the reaction mixture obtained by separation can likewise be worked up to give colloid-chemically stable metal nanoparticle dispersions, which also exhibit good performance properties, particularly with regard to the sintering behavior and the attainment of good conductivities.

In a further embodiment of the method of the invention, setting of the concentration of the metal nanoparticle dispersion in step f) may be accomplished preferably by means of a membrane filtration, more preferably by means of a tangential flow filtration (TFF or cross-flow filtration). In accordance with the invention it is advantageously possible without problems to achieve a concentration of ≧20 wt % of stabilized metal nanoparticles (metal particles coated with dispersing assistant), based on the total amount of the metal nanoparticle dispersion. Tangential flow filtration apparatus, and components thereof, are relatively simple and commercially available. All that is commonly needed is a membrane cassette, a peristaltic pump, one or more pressure measurement apparatuses, and also hose material and fittings. In the case of tangential flow filtration (TFF), it is advantageously possible at the same time for concentration and purification of the metal nanoparticle dispersion to take place, thereby preventing a loss of product through any separate purification step. Tangential flow filtration is further advantageous for the method of the invention since it can be implemented efficiently, rapidly, and simply, with minimal cost and complexity of apparatus. In the case of TFF, for example, the drop in filter performance over the filtration period is relatively low. Moreover, the TFF apparatus can be used again after cleaning and optionally an integrity test.

For further features and advantages of a method of the invention, reference is hereby made explicitly to the explanations in connection with the metal nanoparticle sol of the invention and with the use according to the invention.

The present invention further provides a metal nanoparticle dispersion, more particularly produced by a method of the invention, comprising one or more of the above-described embodiments, comprising at least
≧20 wt % of metal nanoparticles stabilized with at least one dispersing assistant, based on the total amount of the metal nanoparticle dispersion;
at least one liquid dispersion medium comprising at least 50 wt % of a polar solvent, preferably water; and
0-3 wt % of additives,
   where the at least one dispersing assistant has at least one free carboxylic acid group or salt thereof as functional group, and has at least one further ionizable, more particularly protonatable or deprotonatable, functional group. The weight fractions of the components present in the metal nanoparticle sol add up in total to 100 wt %.

The metal nanoparticle sols of the invention are notable advantageously for a high colloid-chemical stability, which is also retained in any concentration process. The properties of the colloidal nanoparticle dispersion of the invention do not change substantially even during the customary storage periods prior to the application. Aggregation or other flocculation of the metal nanoparticles does not occur, for example, even after storage times of more than three months after production.

Furthermore, the metal nanoparticle sols of the invention, produced in particular in accordance with the method of the invention, for the purpose of achieving sufficient conductivities, can require surprisingly low sintering temperatures of ≦140° C., preferably at ≦130° C., as for example at ≦120° C., with relatively short sintering times of ≦30 minutes, preferably sintering times of a few minutes, and may therefore in particular be suitable also for applications involving temperature-sensitive substrates.

Examples of additives which may be present include customary extraneous ions, surfactants, defoamers, and complexing agents, which may further improve the performance properties of the metal nanoparticle dispersion.

In one embodiment, the at least one dispersing assistant preferably has at least one further ionizable, more particularly protonatable or deprotonatable, functional group which is selected from —COOH, —NH—, —SO₃H, —PO(OH)₂, —SH, their salts or derivatives. In accordance with the invention the dispersing assistant may have, for example, two or more identical functional groups, as for example two or more carboxylic acid groups, or else two or more different functional groups. It has emerged advantageously that dispersing assistants of these kinds provide particularly effective stabilization of the metal nanoparticles and therefore that the resultant metal nanoparticle dispersions exhibit a high colloid-chemical stability.

In a further embodiment, the at least one dispersing assistant may preferably be selected from low molecular mass amino acids or their salts, dicarboxylic or tricarboxylic acids having up to 8 carbon atoms or their salts, and mercaptocarboxylic acids having up to 8 carbon atoms or their salts; in the case of chiral compounds, more particularly amino acids, the invention also encompasses their stereoisomers, such as enantiomers and diastereomers, and also their mixtures, for example their racemates. Particularly preferred dispersion stabilizers for stabilizing the metal nanoparticles are N-acetylcysteine, mercaptopropionic acid, mercaptohexanoic acid, citric acid or citrates, such as lithium, sodium, potassium, or tetramethylammonium citrate, for example. In an aqueous dispersion, saltlike dispersing assistants of these kinds are present very largely in dissociated form as their ions, in which case the respective anions may bring about electrostatic stabilization of the metal nanoparticles. The metal nanoparticles, more particularly silver nanoparticles, can advantageously be stabilized particularly effectively via the functional groups available.

In accordance with the invention it is possible for two or more different dispersing assistants, more particularly two or more of the aforementioned dispersing assistants, to be used for the purpose of stabilizing the metal nanoparticles.

In a further embodiment, the invention provides for the use of one or more of the low molecular mass dispersing assistants together with one or more polymeric dispersing assistants comprising at least one carboxylic acid group or carboxylate group as functional group. One example of a polymeric dispersing assistant suitable in accordance with the invention is the ammonium polyacrylate-based dispersing assistant available commercially from Byk under the trade name Byk®154. In accordance with the invention, when different dispersing assistants are employed, they are also referred to as mixed dispersing assistant systems. The polymeric dispersing assistant or assistants is or are preferably used, in relation to the further low molecular mass dispersing assistant or assistants of the invention, in a ratio (w/w) of 1:1500 to 1:2000, preferably of 1:1000 to 1:500, as for example in a ratio of about 1:600.

In one preferred embodiment of the metal nanoparticle sol of the invention, the liquid dispersion medium comprises water or a mixture comprising at least 50 wt %, preferably at least 60 wt %, of water, more preferably at least 70 wt % of water, and organic solvents, preferably water-soluble organic solvents. Suitable and preferred liquid dispersion media are stated in the description of the method of the invention. An especially preferred dispersion medium is water.

In another embodiment, the ratio of the amount-of-substance of silver (Ag) to the amount-of-substance of low molecular mass dispersing assistant or assistants may be preferably (mol/mol) between 1:0.25 and 1:0.75, preferably between 1:0.3 and 1:0.5. This produces optimum coating of the silver nanoparticles with stabilizing dispersing assistant/s, and hence, optionally, surface properties tailored to particular applications. For example, extremely good reprocessibility may be achieved.

For further features and advantages of a metal nanoparticle dispersion of the invention, reference is hereby made explicitly to the explanations in connection with the method of the invention and the use according to the invention.

The metal nanoparticle sols of the invention, more particularly the metal particle sols produced by the method of the invention, are suitable, on account of the low sintering time, for the attainment of sufficient conductivities, more particularly for the production of conductive printing inks, for the production of conductive coatings and conductive structures, and for producing such conductive coatings and conductive structures.

The present invention further provides for the use of the metal particle sols of the invention for producing conductive printing inks, preferably those for inkjet and screen printing processes, conductive coatings, preferably conductive transparent coatings, conductive microstructures and/or functional coats. The metal particle sols of the invention are further suitable for producing catalysts, other coating materials, metallurgical products, electronic products, electroceramics, optical materials, biolabels, materials for forgeproof marking, plastics composites, antimicrobial materials and/or active ingredient formulations.

The invention is elucidated in more detail below by means of examples, but these examples do not restrict the invention to the examples.

### EXAMPLES

### Conductivity Measurements

A film is applied to a glass substrate, by the pouring on of silver nanoparticle sol, and this film is subjected to preliminary drying at 50° C. for approximately 5 minutes. The films dried preliminarily in this way were then sintered at a defined temperature for a defined time. With known film dimensions, the sheet resistance was measured by means of a Nagy SD 600 sheet resistivity meter. The specific conductivity was calculated as the reciprocal of the product of sheet resistance and film thickness.

### Example 1

### Production of a Silver Nanoparticle Sol with BYK®-154 Stabilized Silver Nanoparticles

A mixture of 6.25 g of BYK®-154 and 100 ml of 0.3 M NaOH was added dropwise (0.06 l/min) at room temperature and with stirring to 10 ml of an AgNO₃ solution (71.42 wt %). The solution turned pale brown in color, indicating the formation of Ag2O in the reaction mixture. Then 175 ml of a 37 wt % formaldehyde solution were added at 0.1 l/min with stirring, followed by stirring at 60° C. for a further hour. The reaction mixture underwent a dark brown coloration, indicating the formation of Byk®-54-stabilized silver nanoparticles. The reaction mixture was left to stand undisrupted overnight and then centrifuged at 3000 rpm for 10 minutes, and the silver nanoparticles were redispersed in water with dropwise addition of triethylamine (1-2 mole equivalents). The mixture was purified by means of membrane filtration and concentrated to about 20 wt %. This gave a colloid-chemically stable silver nanoparticle sol on an aqueous basis.

A film of the purified and concentrated silver nanoparticle dispersion was applied to a glass slide and sintered. At a sintering temperature of 220° C., a high specific conductivity of 3×10⁵ S/m was obtained.

### Example 2

### Production of N-Acetyl-L-Cysteine (NALC) Stabilized Silver Nanoparticles with a Molar Ratio of NaOH:NALC of 4:1

7.23 g of NaBH4 in 240 ml of DI water were admixed with 600 ml of 0.35 M NaOH. Added to this system with stirring (750 rpm) were 8.39 g of N-acetyl-L-cysteine in 130 ml of DI water. This mixture was admixed dropwise (approximately 1 drop/sec) with a solution of 25 g of AgNO₃ in 350 ml of DI, followed by stirring for 4 hours more. Accordingly, an amount-of-substance ratio (mol/mol) of NALC to silver of approximately 0.35:1 was used. accordingly Thereafter the reaction mixture was left to stand undisrupted overnight. A floc, in addition to dispersed nanoparticles, was observed at the bottom of the reaction mixture. The pH of the reaction mixture was 10.1. The supernatant reaction mixture with the silver nanoparticles still dispersed was separated from the agglomerate by decanting. The agglomerate was collected with the minimum amount of DI water and redispersed therein. A 50% yield of the theoretically calculated amount of silver nanoparticles was obtained. The agglomerate was further admixed with fresh DI water and redispersed therein. Undispersed particles were then removed by filtration, and the solution was washed with DI water by tangential flow filtration (TFF) with a 10 kilodalton membrane until the filtrate had a value of 7≧pH≦8 (Pall Minimate® TFF), and concentrated to >30 wt % of stabilized silver nanoparticles, based on the total amount of the silver nanoparticle dispersion. This gave a colloid-chemically stable, aqueous silver nanoparticle dispersion. Sintering for 10 minutes at a sintering temperature Ts of 120° C. produced, from the resultant silver nanoparticle dispersion, a film of silver with a specific conductivity of σ_{d.c.}>10⁶ Sm⁻¹.

### Example 3

### Production of N-Acetyl-L-Cysteine Stabilized Silver Nanoparticles with a Molar Ratio of NaOH:NALC of 8:1

a) 2.9 g of NaBH₄ in 100 ml of DI water were admixed with 240 ml of 0.7 M NaOH. Added to this system with stirring (750 rpm) were 3.35 g of N-acetyl-L-cysteine in solution in 50 ml of DI water. This mixture was admixed dropwise (approximately 1 drop/sec) with 10 g of AgNO₃ in 350 ml of DI, followed by stirring for a further 4 hours. Accordingly, an amount-of-substance ratio (mol/mol) of NALC to silver of approximately 0.35:1 was used. Thereafter the reaction mixture was left to stand overnight undisrupted, in other words without stirring or other movement. An agglomerate, in addition to dispersed nanoparticles, was observed at the bottom of the reaction mixture. The pH of the reaction mixture was 12.75, and lay above the pKa of the —NH₂⁺ group of the N-acetyl-L-cysteine (NALC). The supernatant reaction mixture with silver nanoparticles still in dispersion was separated from the agglomerate by decanting. The agglomerate was collected with the minimum amount of DI water and redispersed therein. This gave a yield of 63% (6 g) of the theoretically calculated amount (9.62 g) of agglomerated silver nanoparticles. The agglomerate was redispersed with further DI water and filtered through a Buchner filter, with about 1 g of undispersed solid being removed.

b) The supernatant reaction mixture removed from the agglomerate in 3a), comprising dispersed silver nanoparticles and impurities, was mixed with 5 g of NaOH, stirred for 2 hours and left to stand overnight. A precipitate and a clear, supernatant solution were obtained, the solution having a pH of 13.75, which lay above the pKa of the —NH₂⁺ group of the N-acetyl-L-cysteine (NALC). Scheme 1 below shows the dissociation stages of the NALC. The clear supernatant was decanted off and the precipitate was redispersed in DI water, with about half of the precipitate being insoluble. For the removal of the undissolved constituents and impurities, the dispersion was filtered and combined with the redispersed agglomerate from example 3a), and was washed with DI water by means of TFF with a 10 kilodalton membrane, until the filtrate had a value of 7≧pH≦8 (Pall Minimate® TFF), and concentrated to 20 wt % of stabilized silver nanoparticles, based on the total amount of the silver nanoparticle sol. This gave a colloid-chemically stable silver nanoparticle sol. Investigation of the particle size by dynamic light scattering showed an average effective hydrodynamic diameter of 42.6 nm. The silver nanoparticle sol was investigated by means of UV/Vis spectroscopy using a Shimadzu 1800 UV-VIs spectrometer. The investigation revealed a pronounced plasmon peak at Absₘₐₓ/Abs₅₀₀˜5. The peak maximum was at 395 nm.

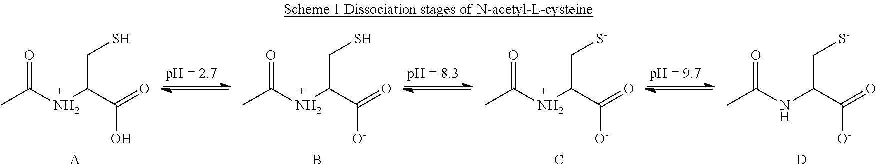

Table 1 shows the results of the conductivity measurements for a coating with a silver nanoparticle sol according to example 3.

TABLE 1
Specific conductivity of sintered N-acetyl-L-cysteine stabilized Ag nanoparticles

| Sinter temp. = 110° C. | | Sinter temp. = 125° C. | | Sinter temp. = 140° C. | | Sinter temp. = 180° C. | |
|---|---|---|---|---|---|---|---|
| 8.9 μm film thickness | | 4.18 μm film thickness | | 10.82 μm film thickness | | 8.67 μm film thickness | |
| Sintering | Specific | Sintering | Specific | Sintering | Specific | Sintering | Specific |
| time | conductivity | time | conductivity | time | conductivity | time | conductivity |
| (min) | (S/m) | (min) | (S/m) | (min) | (S/m) | (min) | (S/m) |
| 0 | 697.63 | 0 | NA | 0 | 1832.6 | 0 | 1647.8 |
| 10 | 2.25E+05 | 1 | 1.4368 | 1 | 9.94E+05 | 1 | 1.17E+06 |
| 20 | 9.99E+05 | 10 | 6.30E+05 | 3 | 1.22E+06 | 2 | 1.31E+06 |
| 35 | 1.36E+06 | 20 | 7.15E+05 | 8 | 1.56E+06 | 7 | 1.40E+06 |
| 50 | 1.54E+06 | 30 | 7.22E+05 | 28 | 1.76E+06 | 17 | 1.40E+06 |
| | | 40 | 7.07E+05 | 48 | 1.88E+06 | 40 | 1.82E+06 |
| | | 50 | 7.64E+05 | | | | |

### Example 4a and 4b

### Production of N-Acetyl-L-Cysteine Stabilized Silver Nanoparticles with a Molar Ratio of NaOH:NALC of 8:1

4a) Example 3 was repeated with twice the concentration of silver, i.e., with 20 g of AgNO₃, with the pH at the end of the reaction being 12.94. A colloid-chemically stable silver nanoparticle dispersion was obtained, which in terms of performance properties was comparable with the silver nanoparticle dispersion obtained in example 3. Analysis of the particle size by means of dynamic light scattering (Malvern Dynamic Light Scattering Particle Size Analyzer) gave an average effective hydrodynamic diameter of 73.8 nm. The silver nanoparticle sol was investigated by means of UV/Vis spectroscopy using a Shimadzu 1800 UV-VIs spectrometer. The investigation revealed a pronounced plasmon peak at Absₘₐₓ/Abs₅₀₀˜5. The peak maximum was at 395 nm.

4b) Example 4a) was again repeated and the results were reproducible. The particle size was investigated by dynamic light scattering and gave an average effective hydrodynamic diameter of 70.4 nm. The silver nanoparticle sol was investigated by means of UV/Vis spectroscopy using a Shimadzu 1800 UV-VIs spectrometer. The investigation revealed a pronounced plasmon peak at Absₘₐₓ/Abs₅₀₀˜5. The peak maximum was at 395 nm.

The higher concentration of the reactants in example 4a and 4b, accordingly, gave a higher average particle size.

N-Acetylcysteine has one thiol group and one additional carboxylic acid group, on which it is possible to bring about strong bonding to the surface of the silver nanoparticles. This can contribute positively to the stability of the silver nanoparticles. In addition, NALC is a small, low molecular mass molecule, which undergoes decomposition advantageously at relatively low temperatures and accordingly permits an advantageously low sintering temperature 130° C.) for the provision of a sufficient conductivity. Furthermore, N-acetyl-L-cysteine is a compound which is not toxic and which is unproblematic in its handling from the standpoints of protection of health, safety at work, environmental management, and quality management (HSEQ). NALC is used in various pharmaceuticals and food supplements.

The silver nanoparticle dispersions obtained from examples 3, 4a and 4b had a surprising colloid-chemical stability and after three months of storage in a brown bottle under ambient conditions (room temperature, atmospheric pressure), for example, showed no substantial agglomeration of the N-acetyl-L-cysteine stabilized silver nanoparticles.

With preference in accordance with the invention, the production of N-acetyl-L-cysteine stabilized silver nanoparticles in step a) is carried out with a molar ratio of NaOH:NALC of between 4:1 and 8:1 in the reaction mixture.

It has been possible to show that with the NALC-stabilized silver nanoparticles produced in accordance with the invention, it is possible to obtain high specific conductivities in the order of magnitude of 10⁶ S/m advantageously even with a particularly low sintering temperature of 110° C. within a sintering time of less than 30 minutes. It was possible to achieve approximately the same specific conductivity with a sintering temperature of 140° C. within a sintering time of less than 3 minutes. No further improvement in the specific conductivity of the silver film was obtainable through higher sintering temperatures, as evident from the values at 180° C.

### Example 5

### Production of Stabilized Silver Nanoparticles with BYK®154 and Sodium Citrate as Dispersing Assistants

A mixture of 8 mg of BYK®154, 188 mg of NaOH, and 4.85 g of sodium citrate in 100 ml of water was mixed with 8 g of silver nitrate (5 wt % in water) and then admixed with 30 ml of formaldehyde (37% strength in water). The weight ratio of BYK®154 to sodium citrate in this case was 1:606. The reaction mixture was left to stand undisrupted overnight and the resulting agglomerate of silver nanoparticles was redispersed in DI water with dropwise addition of triethylamine. The dispersion was then washed with DI water, by means of TFF with a 30 kilodalton membrane, until the filtrate gave a value of 7≧pH≦8 (Pall Minimate® TFF) and was concentrated to 20 wt % of stabilized silver nanoparticles relative to the total amount of the silver nanoparticle sol. This gave a colloid-chemically stable silver nanoparticle sol on an aqueous basis. From this silver nanoparticle sol, on a glass slide, after preliminary drying for 5 minutes at 50° C. and by sintering for 10 minutes at a temperature of 130° C., it was possible to produce a silver film having a specific conductivity of >10⁶ S/.

### Example 6

### Production of Stabilized Silver Nanoparticles with Sodium Citrate as Dispersing Assistant

A mixture of 188 mg of NaOH and 4.85 g of sodium citrate in 100 ml of water was mixed with 8 g of silver nitrate (5 wt % in water) and then admixed with 30 ml of formaldehyde (37% strength in water). The molar ratio of silver nitrate to sodium citrate (mol/mol) in this case was 1:0.35. The reaction mixture was left to stand undisrupted overnight and the resulting agglomerate of silver nanoparticles was redispersed in DI water with dropwise addition of triethylamine. The dispersion was then washed with DI water, by means of TFF with a 10 kilodalton membrane, until the filtrate gave a value of 7≧pH≦8 (Pall Minimate® TFF) and was concentrated to 20 wt % of stabilized silver nanoparticles relative to the total amount of the silver nanoparticle sol. This gave a colloid-chemically stable silver nanoparticle sol on an aqueous basis. From this silver nanoparticle sol, on a glass slide, after preliminary drying for 5 minutes at 50° C. and by sintering for 10 minutes at a temperature of 130° C., it was possible to produce a silver film having a specific conductivity of >10⁶ S/m.

### Example 7

### Production of Stabilized Silver Nanoparticles with Mercaptohexanoic Acid and Mercaptopropionic Acid (1:6 mol/mol) as Dispersing Assistants

Added with stirring to 2.4 g of NaBH₄ in 400 ml of DI water were 500 mg of mercaptohexanoic acid and 2.15 g of mercaptopropionic acid in solution in 100 ml of DI water. Added dropwise (approximately 1 drop/sec) to this mixture were 8 g of AgNO₃ (5 wt % in water). The molar ratio of silver to thiol in this case was 1:0.5 (mol/mol). The reaction mixture was acidified with stirring by dropwise addition of concentrated hydrochloric acid (1N). The reaction mixture was left to stand undisrupted overnight and the resulting agglomerate of silver nanoparticles was redispersed in DI water with dropwise addition of triethylamine. The dispersion was then washed with DI water, by means of TFF with a 10 kilodalton membrane, until the filtrate gave a value of 7≧pH≦8 (Pall Minimate® TFF) and was concentrated to 20 wt % of stabilized silver nanoparticles relative to the total amount of the silver nanoparticle sol. This gave a colloid-chemically stable silver nanoparticle sol on an aqueous basis. From this silver nanoparticle sol, on a glass slide, after preliminary drying for 5 minutes at 50° C. and by sintering for 10 minutes at a temperature of 170° C., it was possible to produce a silver film having a specific conductivity of >10⁶ S/m.

### Example 8

### Production of Stabilized Silver Nanoparticles with Mercaptopropionic Acid as Dispersing Assistant

Added with stirring to 4.4 g of NaBH₄ in 400 ml of DI water were 1.5 g of mercaptopropionic acid in solution in 100 ml of DI water. Added dropwise (approximately 1 drop/sec) to this mixture were 8 g of AgNO₃ (2.5 wt % in water). The molar ratio of silver to thiol in this case was 1:0.3 (mol/mol). The reaction mixture was acidified with stirring by dropwise addition of concentrated hydrochloric acid (1N). The reaction mixture was left to stand undisrupted overnight and the resulting agglomerate of silver nanoparticles was redispersed in DI water with dropwise addition of triethylamine. The dispersion was then washed with DI water, by means of TFF with a 10 kilodalton membrane, until the filtrate gave a value of 7≧pH≦8 (Pall Minimate® TFF) and was concentrated to 20 wt % of stabilized silver nanoparticles relative to the total amount of the silver nanoparticle sol. This gave a colloid-chemically stable silver nanoparticle sol on an aqueous basis. From this silver nanoparticle sol, on a glass slide, after preliminary drying for 5 minutes at 50° C. and by sintering for 10 minutes at a temperature of 120° C., it was possible to produce a silver film having a specific conductivity of >10⁶ S/m.

In accordance with the invention, therefore, it has been possible to provide a method allowing colloid-chemically stable metal nanoparticle dispersions, more particularly silver nanoparticle dispersions, to be obtained on an aqueous basis. The silver nanoparticle dispersions produced by the methods can be used advantageously to produce conductive coatings having a specific conductivity in the order of magnitude of >10⁶ S m by sintering for a few minutes (<30 minutes) at a temperature of ≦140° C. It has been possible to show that with the silver nanoparticle dispersions produced in accordance with the invention, specific conductivities in the order of magnitude of 10⁶ S/m are obtainable even at particularly low sintering temperatures ≦120° C. and even 110° C. within a sintering time of less than 30 minutes. Consequently they may also be suitable in particular for applications involving temperature-sensitive substrates.

1. A method for producing a metal nanoparticle dispersion comprising metal nanoparticles stabilized with at least one dispersing assistant, characterized in that
a) a metal salt, at least one dispersing assistant comprising at least one free carboxylic acid group or salt thereof as functional group, and a reducing agent, optionally in the presence of hydroxide ions, are combined in solution and reacted with one another to form stabilized metal nanoparticles;
b) flocculation of the resultant metal nanoparticles is generated in the reaction mixture obtained in step a);
c) the floc obtained in step b) is separated from at least part of the rest of the reaction mixture;
d) the floc obtained in step c) is redispersed with addition of at least one dispersion medium, optionally with addition of a base;
e) the metal nanoparticle dispersion obtained in step d) is optionally purified; and
f) the desired concentration of stabilized metal nanoparticles for the metal nanoparticle dispersion obtained in step d) or e) is set.

2. The method as claimed in claim 1, characterized in that the at least one dispersing assistant additionally has at least one further ionizable, more particularly protonatable or deprotonatable, functional group.

3. The method as claimed in claim 1, characterized in that a dispersing assistant is selected from low molecular mass amino acids, dicarboxylic or tricarboxylic acids having up to 8 carbon atoms, mercaptocarboxylic acids having up to 8 carbon atoms, their salts, stereoisomers, and derivatives.

4. The method as claimed in at least one of claim 1, characterized in that the flocculation of the resultant metal nanoparticles in step b) is generated by leaving the reaction mixture to stand over a period of 1 minute to 24 h, and/or the flocculation is induced and/or assisted by addition of a base or an acid.

5. The method as claimed in at least one of claim 1, characterized in that the flocculation of the metal nanoparticles in step b) takes place through the setting of the pH of the reaction mixture, corresponding to a pKa of a functional group in the dispersing assistant.

6. The method as claimed in any of claim 1, characterized in that the removal of the floc in step c) from at least part of the rest of the reaction mixture takes place by means of a mechanical separation method.

7. The method as claimed in any of claim 1, characterized in that the reaction mixture separated from the floc in step c) is used again in step b), optionally with addition of a base or an acid.

8. The method as claimed in at least one of claim 1, characterized in that the setting of the concentration in step f) and/or purification of the metal nanoparticle dispersion takes place by means of a tangential flow filtration.

9. A metal nanoparticle dispersion produced by a method as claimed in at least one of claim 1, at least comprising
≧20 wt % of metal nanoparticles stabilized with at least one dispersing assistant, based on the total amount of the metal nanoparticle dispersion;
at least one liquid dispersion medium comprising at least 50 wt % of a polar solvent, preferably water; and
0-3 wt % of additives,
characterized in that the at least one dispersing assistant has at least one free carboxylic acid group or salt thereof as functional group, and has at least one further ionizable, more particularly protonatable or deprotonatable, functional group.

10. The metal nanoparticle dispersion as claimed in claim 9 characterized in that the at least one further ionizable functional group is selected from —COOH, NH, SO3H, PO(OH)2, SH, salts thereof, or derivatives thereof.

11. The metal nanoparticle dispersion as claimed in at least one of claim 9, characterized in that at least one dispersing assistant is a low molecular mass amino acid, dicarboxylic or tricarboxylic acid having up to 8 carbon atoms, and/or a mercaptocarboxylic acid having up to 8 carbon atoms.

12. The metal nanoparticle dispersion as claimed in at least one of claim 10, characterized in that a polymeric dispersing assistant comprising at least one free carboxylic acid group or salt thereof as functional group is additionally present.

13. The metal nanoparticle dispersion as claimed in at least one of claim 10, characterized in that the ratio of the amount-of-substance of metal (Ag) to the amount-of-substance of dispersing assistant or dispersing assistants is 1:0.01 to 1:10.

14. The use of a metal nanoparticle dispersion as claimed in at least one of claim 10 for producing conductive printing inks.

15. The use of a metal nanoparticle dispersion as claimed in at least one of claim 10 for producing conductive coatings or conductive structures.
